(19) United States
(12) Patent Application Publication
(10) Pub. No.: US 2005/0149559 A1
(43) Pub. Date: Jul. 7, 2005

(54) Status monitoring system

(75) Inventors: Carl Oppedahl, Dillon, CO (US); Thomas C. Bennett, Nikiski, AK (US)

Correspondence Address: OPPEDAHL AND LARSON LLP, P O BOX 5068, DILLON, CO, 80435-5068, US

(73) Assignee: OPPEDAHL & LARSON LLP, Dillon, CO (US)

(21) Appl. No.: 10/710,925

(22) Filed: Aug. 12, 2004

Related U.S. Application Data
(63) Continuation-in-part of application No. 09/704,505, filed on Nov. 1, 2000, now Pat. No. 6,789,092.
(60) Provisional application No. 60/162,653, filed on Nov. 1, 1999.

(51) Int. Cl. G06F 7/00

(52) U.S. Cl. 707/104.1

(57) ABSTRACT

A method is described for use with a server serving requested records among a multiplicity of records, and with a predetermined list of record identifiers, and with a first file containing information about records corresponding to the record identifiers. The method comprises the steps of: selecting at least two of the record identifiers from the list; for each one record identifier of the record identifiers: presenting a request to the server with respect to the record identifier; receiving a record from the server, said record corresponding to the record identifier; parsing the record, thereby deriving received information of interest from the record; comparing the received information of interest with corresponding information in the first file; and annunciating any difference between the received information of interest and the corresponding information in the first file.

### CONTINUITY STATEMENT

This is a continuation-in-part of U.S. application Ser. No. 09/704,505, filed Nov. 1, 2000, which claims priority from U.S. Applicaiton No. 60/162,653, filed Nov. 1, 1999, now expired, each of which is incorporated herein by reference for all purposes.

### BACKGROUND

The Internet has given rise to opportunities for ready availability of information that was heretofore only available by more cumbersome means such as telephone calls and inquiries presented in person or by written correspondence. Shippers provide package tracking information on web sites; for example, the US Postal Service provides tracking information regarding Express Mail packages on a web site. The US Patent and Trademark Office provides trademark status information on a web site called TARR (Trademark Application and Registration Retrieval). The Trademark Trial and Appeal Board of the US Patent and Trademark Office provides status information for appeals and inter partes matters, and provides images of filed papers, through its TTABVUE system. The US Patent and Trademark Office provides patent application status information on a web site called PAIR (Patent Application Information Retrieval), and provides images of filed papers through the Image File Wrapper (IFW) system. The PAIR site is provided with a means for establishing a cryptographically secure communications channel so that third parties are unlikely to be able to intercept the patent application status information electronically. The US federal court system provides status of federal litigations through its web-based PACER (public access to court electronic records) system, and provides images of filed papers. The Canadian Intellectual Property Office (CIPO) provides trademark status information on its Strategis web site. The European Patent Office provides patent status information, including images, on its EPOLINE web site. The Organization for Harmonization in the Internal Market (OHIM) provides information on the status of Community Trade Mark (CTM) applications. The World Intellectual Property Organization (WIPO) provides information on the status of international trademark applications under the Madrid Protocol and the Madrid Agreement in its web-based Madrid Express database. WIPO also provides information on international patent applications under the Patent Cooperation Treaty (PCT) in its IPDL.

Unfortunately, many of these web sites have the drawback that it is extremely tedious to check the status of many records. On the web site of the US Postal Service, if it is desired to check the status of several Express Mail packages, the user is forced to hand-type each of the tracking numbers one by one into the server. This not only takes time but also presents the risk that the user may, through inadvertence, type a tracking number incorrectly. A further risk is that the user, checking a list multiple tracking numbers, may forget to check one of the tracking numbers.

Yet a further drawback is that the user is reduced to having to manually (visually) check the present status (as reported on the web site) with the previous status (perhaps reported on a paper printout from a previous status check). This task is tedious, requires awkward paper records, and is error-prone. A human user might not notice that some obscure item of status has changed since the previous status check.

On the TARR web site, the user is likewise forced to type in serial numbers or registration numbers one by one. Each one can be mistyped through inadvertence. Serial numbers or registration numbers can be inadvertently omitted, leading to the unfortunate result that the status is not checked. When status reports are provided by the TARR server, the reports contain lots of information and it is tedious and error-prone to check manually for changes in status from a previous status check.

On the PAIR web site, the user is likewise forced to type in serial numbers or patent numbers one by one. Each one can be mistyped through inadvertence. Serial numbers or patent numbers can be inadvertently omitted, leading to the unfortunate result that the status is not checked. When status reports are provided by the PAIR server, the reports contain lots of information and it is tedious and error-prone to check manually for changes in status from a previous status check. A user may wish to check for new records that are available from the server that match a particular customer number, and this check may result in identifying new records that need status updates. This step is also tedious and risks error, for example if there is new record and if the user fails to notice that a record is new.

Some of these web sites provide images of filed documents. Such web sites include the EPOLINE system, the PACER system, the TTABVUE system, and the US Patent and Trademark Office's IFW (image file wrapper) system which is reachable through the PAIR system. In these systems as they now exist, it is extremely tedious to learn when a new image has been added to a record within the system, and it is tedious to obtain the image and to forward it to a particular person who may wish to review the image.

All of these steps take a very long time. A US patent law firm with a modest-sized docket (e.g. 200 patent files and 200 trademark files) can spend an entire day trying to obtain status changes on its pending files, and tracking the status of the Express Mail packages which it has sent to the Patent Office.

There is thus a great need for a method and system which avoid tedium, which are not error-prone, and which obtain their results quickly.

### SUMMARY OF THE INVENTION

A method is described for use with a server serving requested records among a multiplicity of records, and with a predetermined list of record identifiers, and with a first file containing information about records corresponding to the record identifiers. The method comprises the steps of: selecting at least two of the record identifiers from the list; for each one record identifier of the record identifiers: presenting a request to the server with respect to the record identifier; receiving a record from the server, said record corresponding to the record identifier; parsing the record, thereby deriving received information of interest from the record; comparing the received information of interest with corresponding information in the first file; and annunciating any difference between the received information of interest and the corresponding information in the first file.

### DESCRIPTION OF THE DRAWING

The invention is described with respect to a drawing in several figures, of which:

FIG. 1 shows a system according to the invention; and

FIG. 2 shows a system according to the invention in the particular case of a system employing a cryptographically secure communications channel.

### DETAILED DESCRIPTION

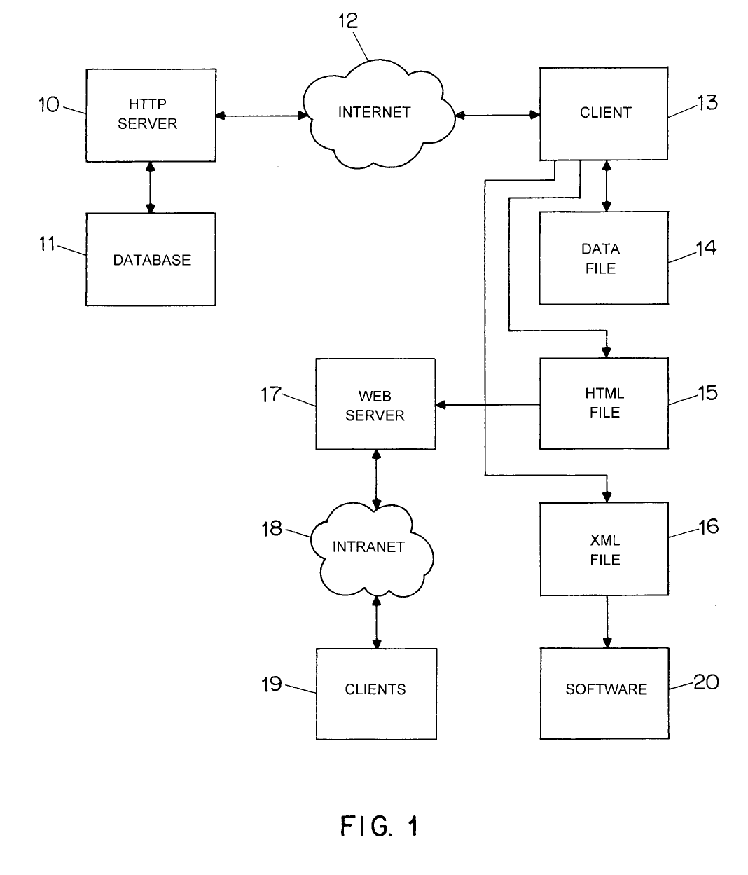

A portion of FIG. 1 can be used to describe the prior art. A hypertext transfer protocol (HTTP) server 10 provides information via the Internet 12, drawn from a database 11. The HTTP server may be for example the above-mentioned IPDL, TTABVUE, PACER, PAIR, TARR, or USPS servers.

In the system according to the invention, a client 13 is preferably a personal computer located at a user's premises, for example an intellectual property law firm omitted for clarity in FIG. 1. The client 13 runs software according to the invention which performs most of the steps described herein.

As mentioned earlier, the server 10 serves requested records among a multiplicity of records from a database 11. The client 13 draws upon a predetermined list of record identifiers stored in a data file 14. For convenience the file 14 may also contain information about records corresponding to the record identifiers. As mentioned below, however, the invention does not require that the list of record identifiers be stored in the same data file as the information about records.

The client 13 then performs an update. This update may be manually initiated by a user, or may be an automated process such as a Windows service or a Linux cron job. The client 13 selects at least one record identifier, though in most cases the client 13 will select at least two of the record identifiers from the list, and in some cases the client 13 will select all records matching a criterion or may match all records in the database.

In a preferred embodiment, each record identifier has associated with it a “frequency” relating to how often it is desired to perform an update. This may be daily, weekly, monthly, or never, in an exemplary system. The client 13 will then select records based on whether each record is scheduled for an update on the present day.

The client 13, for each one record identifier of the record identifiers, performs a number of steps. It presents a request to the server with respect to the record identifier. It receiving a record from the server, the record corresponding to the record identifier. (Another possible outcome is a timeout if, for example, the server fails to respond timely.)

The client 13 parses the record, thereby deriving received information of interest from the record. This is a nontrivial task, especially considering that the US Postal Service or the US Patent and Trademark Office may, without warning, change the format or syntax of its web page status reports, thus crippling the status monitoring software according to the invention. Parsed information is obtained from the HTTP response. For example, in the case of a trademark record, the parsing software extracts the filing date, the examining group, the expected publication date, the most recent status, and other information. In the case of a patent record, the parsing software extracts the examiner's name, the group art unit, the foreign priority data, the continuity data, and the most recent status, among other information.

The client 13 then compares the received information of interest with corresponding information in the first file 14. It annunciates any difference between the received information of interest and the corresponding information in the first file 14. This is preferably done by sending email to predetermined recipients and by flagging such events by means of distinctive characters on a status display screen and in the HTML and XML files mentioned below.

In the general case, the client 13 replaces the information in the first file 14 with the received information of interest. This means that the system has current status information which may be compared on future days with status information retrieved in the future.

It will be appreciated that the steps carried out by the client 13 are not performed manually by a human user operating a web browser and typing characters into the web browser. Instead and in contrast, the steps carried out by the client 13 are performed by means of a stored program in appropriate hardware such as a general-purpose personal computer.

In the case of a system that makes images available, the client 13 checks to see what images were previously listed as being available, and if one or more additional images now are listed as being available, then the system downloads the new images. These images are preferably emailed to particular recipients. For example the client 13 may have a database of records listing the files to be monitored, and each record may have a respective email address representing a recipient who is to receive updates regarding that record, including new images for that record in the case of a system providing images. More than one email address may be stored so that the update may be emailed to two or more interested persons.

It is desirable, in the case of a multipage document, to collect the images of the pages of the document and to stitch the images together into a multipage file such as a multipage TIF file or a multipage PDF file. The multipage file is preferably stored for future reference and is preferably emailed to an interested person or persons.

It is desirable in addition to have the client 13 create or update an extensible markup language (XML) file 16 which may be processed by other software 20. In addition, it is desired to create or update a hypertext markup language (HTML) file 15 containing the information in the first file 14 but in HTML form. Such a file is preferably then served by means of a web server 17, via an intranet 18, to clients 19 within the intellectual property law firm, again omitted for clarity in FIG. 1.

Experience shows that the designers of some of the web-based systems choose to design their systems so that a predictable URL (uniform resource locator) may be used to view a particular image. For example in TTABVUE a particular image will have the same URL every time a visitor searches for and arrives at the particular image. Substituting a different serial number or proceeding number in the URL will find a corresponding image in the records of another serial number or proceeding. From the user's point of view this is a very user-friendly quality of the design of the system.

Even if a URL is not particularly predictable, it is extremely desirable that the the URL be time-independent and session-independent. By this what is meant is that a user could “bookmark” a URL for an image, and return hours or days later, and the bookmark would still work. By this what is also meant is that a user could send the URL to someone else by email, or could use the URL in a web link, and the URL and link would work just as well even days later. From the user's point of view this is a very important quality for a user-friendly web site.

Some systems, in contrast, have long URLs (dozens or even hundreds of characters in length) which contain dozens of seemingly random characters. Experience often shows that such URLs are neither time-independent nor session-independent. If the user bookmarks such a URL, it won't work the next day. If the user emails the URL to a colleague, the colleague will get no benefit from the URL as it won't work even five minutes later. Such a URL is typically tied to session-specific information such as “cookies” which explains why it does not work for the colleague. Experience shows that with such URLs it is generally impossible to substitute one serial number for another within the URL to obtain any meaningful result for the new serial number.

In the case where the URL is user-friendly (time- and sesson-independent) the client 13 may make great benefit from such a URL. For example, when the client 13 learns that a new image is available, the client 13 may desirably email the link (the URL) to a user. The user can then read the email message, see the link, click on it, and then view the image. This saves having to email the image file itself, which takes up space in a mail spool or in a user's email in-box. In addition, in the HTML page or XML page generated by the client 13, the URL can be embedded into the HTML or XML page which allows a user who views the HTML or XML to click on the link and to view the new image.

In the case where a system has “unfriendly” URLs (e.g. URLs that don't work more than once and that are session-dependent or time-dependent or both) it does no good to attempt to email a system image URL to a user, and it does no good to attempt to embed the URL into an HTML or XML page. When the client 13 is used with such a system, the preferable approach is simply to download the image and to store it in a local server such as a local web server. The operator of the local web server can establish user-friendly URLs for such image files. This can be done manually by a webmaster or can be done automatically and “on the fly” by a system such as a PHP program. Such a URL can be emailed to a colleague or user and it will work days or months later.

In the HTML or XML page created by the client 13, it is preferable for each image link to provide a column indicating the date on which the image file was downloaded or first made available by “friendly” URL link.

Those skilled in the art will appreciate that the protocol used between client 13 and server 10 are necessarily determined by the server 10. In the present day, the served records are in the hypertext markup language file and the server 10 is a hypertext transfer protocol server, which means that the client 13 must be an HTTP client receiving and parsing HTML data. If the server 10 were serving XML records, then the client 13 would have to receive and parse XML data. While the latter is desirable from the programming point of view, the designer of the client 13 is constrained by the decisions made by the operator of the server 10, for example the US Postal Service or the US Patent and Trademark Office.

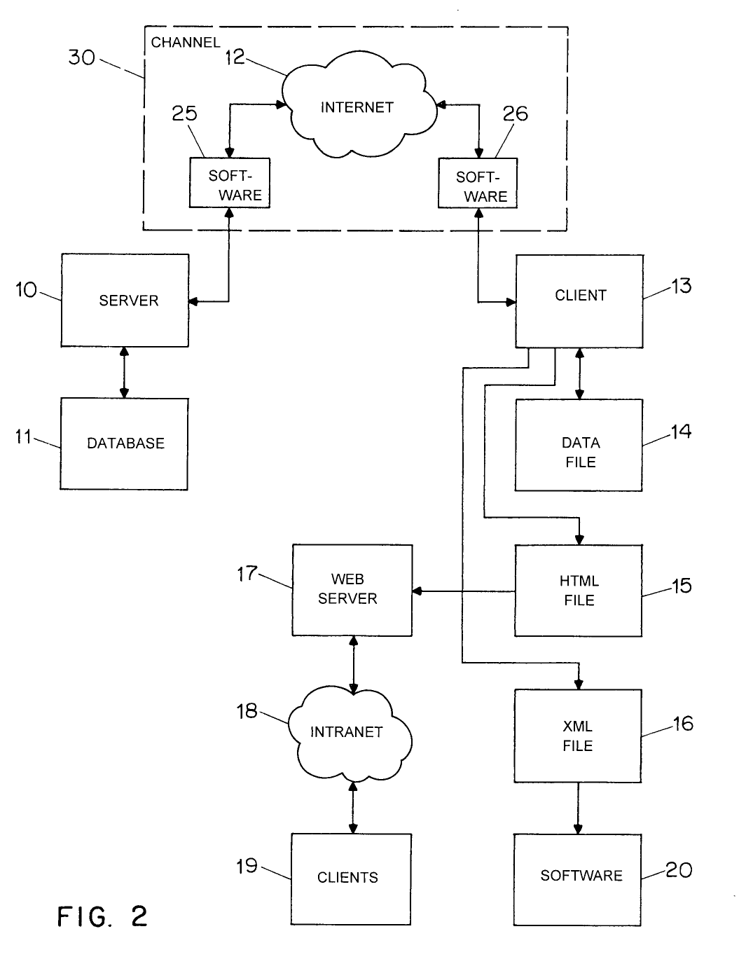

FIG. 2 shows how the system of FIG. 1 changes when a cryptographically secure communications link with the server is employed. In the case of the PAIR server, the US Patent and Trademark Office has determined that the user will employ software called USPTO Direct 26 which, together with corresponding software 25, creates a cryptographically secure channel 30 between the server 10 and the client 13. Those skilled in the art will appreciate that the particular cryptographic approach employed is not material to the invention, and that other approaches such as point-to-point tunneling protocol or SSH protocol could just as well be used, a decision likewise not material to the invention.

In the case of PAIR, the the record identifiers are patent application serial numbers or patent numbers. In the case of TARR and the OHIM database and the Strategis trademarks database, the record identifiers are trademark application serial numbers or trademark registration numbers. In the case of Express Mail, the record identifiers are package tracking numbers. In the case of TTABVUE, the record identifiers are trademark application serial numbers and proceeding numbers. In the case of the Madrid Express database, the record identifiers may be international registration numbers. In the case of EPOLINE and the WIPO IPDL, the record identifiers are patent application serial numbers.

The PAIR server presents an additional opportunity for the designer of the client 13. The client 13 can request from the server 10 all record identifiers matching a predetermined criterion such as the customer number, and can add any new record identifiers to the predetermined list of record identifiers. Stated differently, the client 13 can compare the retrieved list of serial numbers and compare it with those stored in data file 14, and can annunciate new serial numbers. This can happen for example if a newly filed patent application finds its way into PAIR, or if an existing patent application comes to have the user's customer number associated with it.

Those skilled in the art will have no difficulty devising obvious enhancements and improvements to what is described here, all without departing from the invention, all of which are intended to be encompassed within the claims which follow.

1. A method for use with a server serving requested records among a multiplicity of records, and with a predetermined list of record identifiers, and with a first file containing information about records corresponding to the record identifiers, the method comprising the steps of:
selecting at least two of the record identifiers from the list;
for each one record identifier of the record identifiers:
by means of a stored program, presenting a request to the server with respect to the record identifier;
receiving a record from the server, said record corresponding to the record identifier;
parsing the record by means of a stored program, thereby deriving received information from the record indicative of available images;
by means of a stored program, comparing the derived information with corresponding information in the first file; and
in response to any difference between the received information of interest and the corresponding information in the first file, obtaining the newly available image or images.

2. The method of claim I wherein there are two or more newly available images, further comprising the step of combining the images into a single multipage image file.

3. The method of claim 1 further comprising the step, performed after the parsing step, of replacing the information in the first file with the received information of interest.

4. The method of claim 3 further comprising the step of creating or updating an extensible markup language file containing the information in the first file.

5. The method of claim 3 further comprising the step of creating or updating a hypertext markup language file containing the information in the first file.

6. The method of claim 1 further comprising the step of annunciating any difference between the received information of interest and the corresponding information in the first file.

7. The method of claim 6 wherein the annunciating step further comprises emailing the newly available image or images to the recipient.

8. The method of claim 2 further comprising an annunciating step comprising emailing the single multipage image file to a recipient.

9. The method of claim 1 wherein the server is a hypertext tansfer protocol server, and the presenting and receiving steps are performed according to a hypertext transfer protocol.

10. The method of claim 5 further comprising the step of serving records in the hypertext markup language file on a hypertext transfer protocol server.

11. The method of claim 1 wherein the presenting and receiving steps are performed by means of a cryptographically secure communications link with the server.

12. The method of claim 11 wherein the server is a hypertext transfer protocol server, and the presenting and receiving steps are performed according to a hypertext transfer protocol.

13. The method of claim 1 wherein the record identifiers are patent application serial numbers.

14. The method of claim 1 wherein the record identifiers are trademark application serial numbers.

15. The method of claim 1 further comprising the steps of requesting from the server all record identifiers matching a predetermined criterion, and adding any new record identifiers to the first file.

16. The method of claim 15 further comprising the step of annunciating any new record identifiers.

17. The method of claim 16 wherein the annunciating of new record identifiers comprises sending an email message.

18. The method of claim 15 wherein the predetermined criterion comprises matching a customer number.

19. A system for use with a server serving requested records among a multiplicity of records, the system comprising:
a predetermined list of record identifiers;
a first file containing information about records corresponding to the record identifiers;
first means for selecting at least two of the record identifiers from the list;
second means with respect to each one record identifier of the record identifiers for: presenting a request to the server with respect to the record identifier;
receiving a record from the server, said record corresponding to the record identifier;
parsing the record, thereby deriving received information from the record indicative of available images;
comparing the derived information with corresponding information in the first file; and
in response to any difference between the received information of interest and the corresponding information in the first file, obtaining the newly available image or images.

20. The system of claim 19 wherein the second means further performs the step, performed after the parsing step, of replacing the information in the first file with the received information of interest.

21. The system of claim 20 wherein the second means further performs the step of creating or updating an extensible markup language file containing the information in the first file.

22. The system of claim 20 wherein the second means further performs the step of creating or updating a hypertext markup language file containing the information in the first file.

23. The system of claim 19 wherein the second means further performs a step of annunciating any difference between the received information of interest and the corresponding information in the first file.

24. The system of claim 19 wherein the server is a hypertext transfer protocol server, and the presenting and receiving are performed according to a hypertext transfer protocol.

25. The system of claim 22 further comprising a hypertext transfer protocol server serving records in the hypertext markup language file.

26. The system of claim 19 further comprising cryptographic means establishing a cryptographically secure communications link with the server.

27. The system of claim 19 wherein there is further provided a third means responsive to there being two or more newly available images, for combining the images into a single multipage image file.

28. A method for use with a server serving requested records among a multiplicity of records, and with a predetermined list of record identifiers, and with a first file containing information about records corresponding to the record identifiers, the method comprising the steps of:
selecting at least two of the record identifiers from the list;
for each one record identifier of the record identifiers:
by means of a stored program, presenting a request to the server with respect to the record identifier;
receiving a record from the server, said record corresponding to the record identifier;
by means of a stored program, parsing the record, thereby deriving received information of interest from the record;
by means of a stored program, comparing the received information of interest with corresponding information in the first file; and
by means of a stored program annunciating any difference between the received information of interest and the corresponding information in the first file.

29. The method of claim 28 further comprising the step, performed after the parsing step, of replacing the information in the first file with the received information of interest.

30. The method of claim 29 further comprising the step of creating or updating an extensible markup language file containing the information in the first file.

31. The method of claim 29 further comprising the step of creating or updating a hypertext markup language file containing the information in the first file.

32. The method of claim 28 wherein the annunciating step further comprises sending an email to a recipient.

33. The method of claim 28 wherein the server is a hypertext transfer protocol server, and the presenting and receiving steps are performed according to a hypertext transfer protocol.

34. The method of claim 31 further comprising the step of serving records in the hypertext markup language file on a hypertext transfer protocol server.

35. The method of claim 28 wherein the presenting and receiving steps are performed by means of a cryptographically secure communications link with the server.

36. The method of claim 35 wherein the server is a hypertext transfer protocol server, and the presenting and receiving steps are performed according to a hypertext transfer protocol.

37. The method of claim 28 wherein the record identifiers are patent application serial numbers.

38. The method of claim 28 wherein the record identifiers are trademark application serial numbers.

39. The method of claim 28 wherein the record identifiers are package tracking numbers.

40. The method of claim 28 further comprising the steps of requesting from the server all record identifiers matching a predetermined criterion, and adding any new record identifiers to the first file.

41. The method of claim 40 further comprising the step of annunciating any new record identifiers.

42. The method of claim 41 wherein the annunciating of new record identifiers comprises sending an email message.

43. The method of claim 40 wherein the predetermined criterion comprises matching a customer number.

44. A method for use with a server serving requested records among a multiplicity of records, and with a predetermined list of record identifiers, and with a first file containing information about records corresponding to the record identifiers, the method comprising the steps of:
selecting at least two of the record identifiers from the list;
for each one record identifier of the record identifiers:
by means of a stored program, presenting a request to the server with respect to the record identifier;
receiving a record from the server, said record corresponding to the record identifier;
parsing the record by means of a stored program, thereby deriving received information from the record indicative of available images;
by means of a stored program, comparing the derived information with corresponding information in the first file; and
in response to any difference between the received information of interest and the corresponding information in the first file, identifying a uniform resource locator for each of the newly available image or images.

45. The method of claim 44 further comprising the step, performed after the parsing step, of replacing the information in the first file with the received information of interest.

46. The method of claim 45 further comprising the step of creating or updating an extensible markup language file containing the information in the first file and embedding the uniform resource locator in the extensible markup language file.

47. The method of claim 45 further comprising the step of creating or updating a hypertext markup language file containing the information in the first file and embedding the uniform resource locator in the hypertext markup language file.

48. The method of claim 45 further comprising the step of annunciating any difference between the received information of interest and the corresponding information in the first file wherein the annunciating further comprises sending an email to a recipient containing the uniform resource locator.

49. The method of claim 44 wherein the server is a hypertext transfer protocol server, and the presenting and receiving steps are performed according to a hypertext transfer protocol.

50. The method of claim 47 further comprising the step of serving records in the hypertext markup language file on a hypertext transfer protocol server.

51. The method of claim 44 wherein the presenting and receiving steps are performed by means of a cryptographically secure communications link with the server.

52. The method of claim 51 wherein the server is a hypertext transfer protocol server, and the presenting and receiving steps are performed according to a hypertext transfer protocol.

53. The method of claim 44 wherein the record identifiers are patent application serial numbers.

54. The method of claim 44 wherein the record identifiers are trademark application serial numbers.

55. The method of claim 44 further comprising the steps of requesting from the server all record identifiers matching a predetermined criterion, and adding any new record identifiers to the first file.

56. The method of claim 55 further comprising the step of annunciating any new record identifiers.

57. The method of claim 56 wherein the annunciating of new record identifiers comprises sending an email message.

58. The method of claim 55 wherein the predetermined criterion comprises matching a customer number.

59. A system for use with a server serving requested records among a multiplicity of records, the system comprising:
a predetermined list of record identifiers;
a first file containing information about records corresponding to the record identifiers;
first means for selecting at least two of the record identifiers from the list;
second means with respect to each one record identifier of the record identifiers for:
presenting a request to the server with respect to the record identifier;
receiving a record from the server, said record corresponding to the record identifier;
parsing the record, thereby deriving received information from the record indicative of available images;
comparing the derived information with corresponding information in the first file; and
in response to any difference between the received information of interest and the corresponding information in the first file, identifying a uniform resource locator for each of the newly available image or images.

60. The system of claim 59 wherein the second means further performs the step, performed after the parsing step, of replacing the information in the first file with the received information of interest.

61. The system of claim 60 wherein the second means further performs the step of creating or updating an extensible markup language file containing the information in the first file and embedding the uniform resource locator for each of the newly available image or images.

62. The system of claim 60 wherein the second means further performs the step of creating or updating a hypertext markup language file containing the information in the first file and embedding the uniform resource locator for each of the newly available image or images.

63. The system of claim 59 wherein the second means further performs a step of annunciating any difference between the received information of interest and the corresponding information in the first file and wherein the annunciating further comprises sending email to a recipient including the uniform resource locator.

64. The system of claim 59 wherein the server is a hypertext transfer protocol server, and the presenting and receiving are performed according to a hypertext transfer protocol.

65. The system of claim 62 further comprising a hypertext transfer protocol server serving records in the hypertext markup language file.

66. The system of claim 59 further comprising cryptographic means establishing a cryptographically secure communications link with the server.

67. A method for use with a server serving requested records among a multiplicity of records, and with a predetermined list of record identifiers, and with a first file containing information about records corresponding to the record identifiers, the method comprising the steps of:
selecting at least two of the record identifiers from the list;
for each one record identifier of the record identifiers:
by means of a stored program, presenting a request to the server with respect to the record identifier;
receiving a record from the server, said record corresponding to the record identifier;
by means of a stored program, parsing the record, thereby deriving received information of interest from the record;
by means of a stored program, comparing the received information of interest with corresponding information in the first file; and
by means of a stored program annunciating any difference between the received information of interest and the corresponding information in the first file.

68. The method of claim I wherein the record identifiers are package tracking numbers.

69. The method of claim 44 wherein the record identifiers are package tracking numbers.
